(19) United States
(12) Patent Application Publication
(10) Pub. No.: US 2007/0126226 A1
(43) Pub. Date: Jun. 7, 2007

(54) Two-part security sticker and document system therefor

(76) Inventors: Thomas R. Kolodzie, Hamburg (DE); Domenica Kirchmeyer, Grevenbroich (DE); Mario Ergovic, Zagreb (HR)

Correspondence Address: 3M INNOVATIVE PROPERTIES COMPANY, PO BOX 33427, ST. PAUL, MN, 55133-3427, US

(21) Appl. No.: 10/555,499

(22) PCT Filed: May 10, 2004
(86) PCT No.: PCT/US04/14614

§ 371 Date: Nov. 20, 2006

(30) Foreign Application Priority Data
May 28, 2003 (EP) 03101558.9

(51) Int. Cl. B42D 15/00

(52) U.S. Cl. 283/72

(57) ABSTRACT

A security sticker and a document retrieval system therefor is described, wherein the sticker comprises one or more security features on a backing layer having opposite first and second major sides, said first major side having a transparent or translucent adhesive layer applied at least to a first part thereof and a liner on aside of the adhesive layer remote from said backing layer. The first major side has in the first part of said security sticker a first area containing one or more indicia describing first information to be displayed and to be protected against forgery and/or tampering in a first mode of use and said second major side has in a second part of said security sticker a second area located opposite to a third area on said first major side that does not contain information to be displayed and protected in said first mode of use. The second area comprises a section being adapted to receive second information or containing second information, said second information being related to third information contained on said first major side in said first part or to all or a part of said first information. in such a way that said third information or said all or part of said first information can be derived from said second information. In use the first part is attached to a transparent object and the second part is attached to a document.

### FIELD

The present invention relates to an informative security device for attaching to a surface by means of an adhesive layer, for example a sticker as well as a method of making the same. The sticker contains information that is protected against forgery by one or more security features. The sticker is generally intended for adhering to transparent substrates and contains an adhesive layer on the side containing the information that is to be protected. This information will be visible through the transparent substrate when the sticker is adhered thereto.

The present invention also relates to a system of maintaining information relating to transport vehicles including a plurality of security stickers.

### BACKGROUND

Security stickers are well known in the art and have been used for a variety of purposes. For example, security stickers have been used in connection with motor vehicles to certify for example that certain government regulations have been complied with, e.g. that the motor vehicle is properly insured or that requisite taxes have been paid. Such security stickers typically contain one or more security features to protect the information on the sticker against copying or modification. Typically, security stickers for use with a motor vehicle may be adhered to the inside of a window, e.g. the windshield of the motor vehicle such that the information on the security sticker is visible for inspection by looking through the windshield.

Although the information on the sticker may be well secured, forgery may still occur in that one may attempt to remove the sticker from one motor vehicle and affix the sticker to another motor vehicle. The art has therefore sought to solve this problem.

While known solutions may be effective to prevent a sticker from being transferred from one vehicle to another or detect when a sticker has been tampered with, the known solutions are complicated and may be expensive. It would therefore be desirable to find alternative solutions that are simpler but can nevertheless provide good security. Known systems do not provide a complete security system with proper documentation of the use of the sticker and not just a single item such as a sticker. These known systems are also not compatible with modern technologies such as wireless mobile communication technology.

### SUMMARY

The present invention provides a security sticker comprising one or more security features on a backing layer having opposite first and second major sides, said first major side having a transparent or translucent adhesive layer applied at least to a first part thereof and a liner on a side of the adhesive layer remote from said backing layer, said first major side having in the first part of said security sticker a first area containing one or more indicia describing first information to be displayed and to be protected against forgery and/or tampering in a first mode of use and said second major side having in a second part of said security sticker a second area located opposite to a third area on said first major side that does not contain information to be displayed and protected in said first mode of use, said second area comprising a section being adapted to receive second information or containing second information and said second information being related to all or a part of said first information. The relationship may be such that said all or part of said first information can be derived from said second information. The first mode of use may be fixing of the sticker to a transparent substrate by means of the transparent or translucent adhesive layer. For example, in use the sticker according to the present invention can adhered to a transparent part of a transport vehicle, e.g. to the inside of the windshield such that the information on the sticker is visible through the transparent part. The sticker also allows for simple verification as to whether the sticker is attached to the correct vehicle by information printed on or to be printed on the second area on the second major side in the second part of the sticker. This second part can be separated from the first part of the sticker and may be attached to a document that belongs to the car such as for example a car registration document. Since the second information on the second part of the sticker is related to some information on the first part of the sticker or is protected against forgery, such that the latter information can be derived from the second information, inspection of the document and the sticker can easily reveal whether the sticker belongs to the car. The second part of the sticker may also include an adhesive layer and a liner, the adhesive layer being applied to the first major surface.

Furthermore, the sticker allows for easy customization by the issuing authorities of the sticker in that the authority can include additional security in the information printed in the second part on the second major side. For example, the information printed can be variable, i.e. include information unique to the sticker and may further be encrypted. Accordingly, this further protects against forgery.

The present invention also provides a document security system comprising: the security sticker described above; a first object, such as a vehicle or other object, having the first part of the sticker attached thereto; and a second object, such as a document, having the second part of the sticker attached thereto.

The present invention also provides an arrangement for maintaining documents related to transport vehicles and other objects comprising at least one sticker as described above but with the second part removed, and at least one document to which the second part has been fixed. The system may also includes at least one transport vehicle or other object to which the first part of the sticker has been applied to a transparent portion thereof, e.g. to a windshield. Further, the system may include a computer system for storing information related to the first or second information or other information related to this information.

The present invention will now be described with reference to the following drawings.

### BRIEF DESCRIPTION OF THE DRAWINGS

FIG. 1 is a schematic representation of on side of a sticker in accordance with an embodiment of the present invention.

FIG. 2 is a schematic representation of the other side of the sticker of claim 1.

FIG. 3 is a cross-section through the sticker of FIGS. 1, 2 along a line 3-3.

FIG. 4 is a schematic representation of an arrangement for maintenance of information relating to transport vehicles in accordance with a further embodiment of the present invention.

### DETAILED DESCRIPTION OF PREFERRED EMBODIMENTS

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes.

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

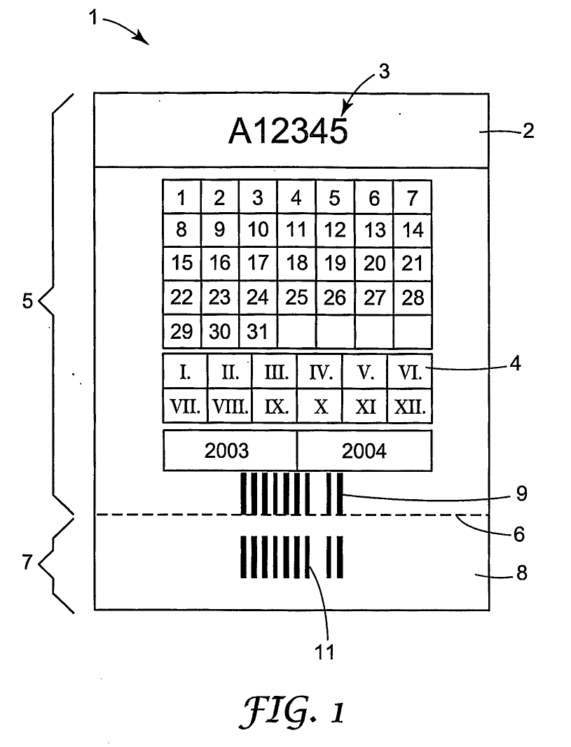

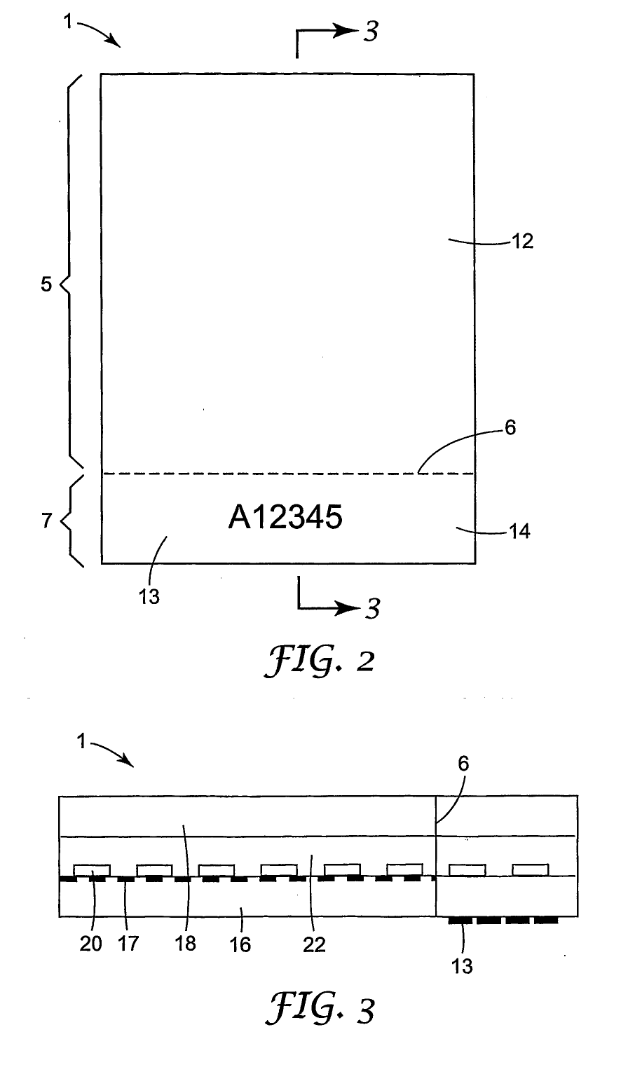

An aspect of the present invention is an informative security device 1 for attaching to a surface by means of an adhesive layer and will be described with reference to FIGS. 1 to 3. FIG. 3 is a cross-section through the device 1 of FIGS. 1 and 2 along the line 3-3. The device 1 may be described as a security sticker comprising one or more security features on a backing layer 16 having opposite first and second major sides. The first major side has a transparent or translucent adhesive layer 22 applied at least to a first part 5 (see FIG. 2) thereof and a release liner 18 on the side of the adhesive layer 22 remote from the backing layer 16. The term “translucent” refers to an adhesive layer which allows light to pass through it but which is not necessarily perfectly clear. Major information elements of an image recorded on the first major side of the backing layer are preferably readable through the translucent adhesive layer. “Transparent” refers to a property of an adhesive layer which allows an image to be viewed through the layer without any significant distortion.

The backing layer 16 is preferably flexible, e.g. made of polymeric, metal or cellulosic material or a combination of any of these. The release liner 18 is also preferably made of a flexible material, e.g. of a polymeric material. Thus, the release liner is preferably a release foil. The release liner 18 is made of a material or is coated with a material which has a low peel strength with respect to the adhesive layer 22 such that the release liner 18 can be removed from the sticker 1 to expose the adhesive layer 22 without activating any of the security features of the sticker 1 and without damaging the adhesive layer 22 or the backing layer 16 in a significant way.

On the first major side of the backing layer 16 in the first part 5 thereof is provided first information to be displayed and to be protected against forgery and/or tampering in a first mode of use of the sticker 1. See FIG. 1. The first information may include a first area 2 having one or more indicia 3 describing a serial number such as “A12345”, each number being unique for each sticker and being pre-marked onto the sticker. The first information will typically include printed indicia, e.g. printed by a suitable printing technique such as ink jet, thermal mass transfer, laser, offset, gravure printing etc. First information further may include information 4 described through punching of the sticker. For example the information 4 may be a calendar comprising years/months/days or similar elements of which can be punched in order to record a certain date, e.g. a date of expiry or of validity, or money values which can be punched in accordance with a fee paid. Instead of punching holes in the sticker 1, other methods of permanent marking can be used, e.g. embossing.

The first mode of use is when the sticker 1 is applied to a transparent substrate, e.g. a transparent part of a transport vehicle or other object that needs to be marked with the sticker. The transparent substrate could be, for instance, a window of a permanent or temporary dwelling, such as a house or caravan or a transparent part of machine or office equipment. The first information 3 is preferably applied to the first side of the backing layer 16 beneath the adhesive layer 22 but this information could be applied to the reverse side provided the information is readable through the backing layer 16 although this is less preferred. The second major side of the sticker 1 has in a second part 7 and a second area 14 located opposite to a third area 8 on said first major side that does not contain information to be displayed and protected in said first mode of use. The second area 14 comprises a section being adapted to receive second information 13 or containing second information 13 and said second information 13 is related to all or a part of said first information in such a way that said all or part of said first information can be derived from said second information, e.g. the information is identical or obtained by a suitable encoding or decoding or transformation operation. The sticker 1 also allows for simple verification as to whether the sticker 1 is attached to the correct vehicle by the second information 13 printed on or to be printed onto the second area 14 on the second major side in the second part 7 of the sticker 1. Optionally, the area 14 may be custom printed or marked by the issuing authority even with a completed sticker. For example, the information printed can be variable, i.e. include information unique to the sticker and may further be encrypted. Accordingly, this further protects against forgery and/or tampering. The present invention also includes a plurality of second parts, each separable from any other part and each for attachment to a document or to any other object.

This second part 7 can be separated from the first part 5 of the sticker 1. For example, a mark or line 6 may be provided at the junction of the first and second parts 5, 7, e.g. as a guide for cutting with scissors or with a guillotine. This line 6 may also be formed from one or more mechanical weaknesses, e.g. perforations, that allow tearing of the first part 5 from the second part 7. For example, one or more ends of the line 6 may be provided with a notch to promote tearing along line 6. The reverse side 12 of the first part 5 may be left blank or provided with relevant information, e.g. a legal notice warning of the consequences of fraud or tampering.

Preferably, the first and second information are related by a unique relationship between them, the unique relationship being proof that the first and second information belong to each other. The relationship may be an information-content relationship. For example, the first and second information may be identical or the first information is derivable from the second information or vice versa. For example, the first information may be in alphanumeric form and the second information may be a bar code representation of that alphanumeric information, or vice versa. In this case, the first and second information are content related even though they are not form related. Alternatively, the first and second information may be cryptographically related, e.g. the first information may be an encryption key and the second information is information encrypted using the key, or vice versa. The first and second information may be both cryptographically and information-content related. For example, the second information is the result of the application of cryptographic process, e.g. a one-way function on the first information. The result of the encryption can be alphanumeric but it can also be other representations such as an image which is generated from alphanumeric first information or vice versa.

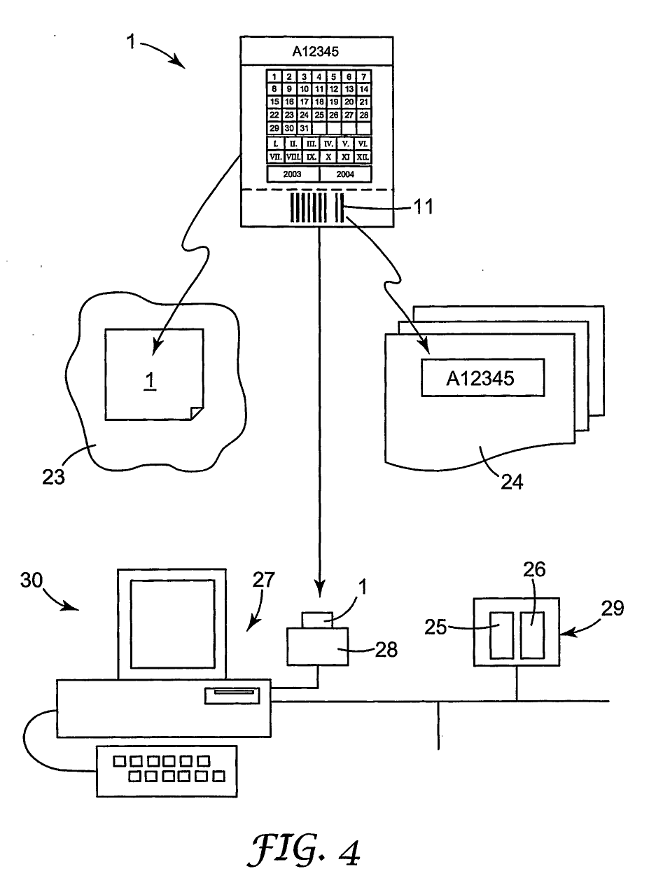

Optionally, additional information may be provided on the first major surface of the sticker 1. For instance a 1-dimensional or 2-dimensional bar code 9, 11 or similar may be applied to the first and/or second part 5, 7. This bar code 9, 11 may code for the same information as is displayed in information 3. The bar code 9,11 allows machine reading of this data by a suitable barcode reader as well as automatic storing of this information, in particular recording and storing of this information in a remote computer system (see FIG. 4 and the description below). It also allows reading of this data by means of a mobile device such as a mobile phone either directly using a mobile phone equipped with a camera or an integrated mobile phone and bar code reader. This allows rapid checking of the details of a vehicle by authorized personnel such as a policeman, border or security guard by sending the relevant data or picture back to a centralized computer system.

The sticker 1 is preferably multilayered. The multilayer sticker 1 preferably contains one or more security features. A security feature may be one or more of the following:
1) Structures or elements which make forgery more difficult. Examples of these include a watermark; lenses or retroreflective microelements such as transparent spheres, e.g. glass beads, or cube comers made of materials such as vinyl, polycarbonate, or acrylic for embossed cube-comer elements and urethane, epoxy, polyester, and acrylic oligomers and monomers for radiation-cured cube-comer elements; holograms; kinegrams; complex finely printed structures; magnetic and metal layers; a microchip such as a memory chip or microprocessor with memory as is known from smartcards, bank cards, credit cards and telephone pre-payment cards.
2) Structures or elements which make tampering with the sticker 1 more difficult. Examples of these include patterned adhesive layers which break up or disintegrate when an attempt is made to remove the sticker from the substrate when adhered, one or more easily extensible layers which deform plastically and permanently when an attempt is made to remove the sticker. Generally, the adhesive layer 22 of sticker 1 can be designed to have very high adhesion to a smooth surface such as glass and to give permanent bonding, so that the sticker 1 can be removed only with the aid of solvents and/or mechanical scraping. Through the use of solvents and/or mechanical scraping the sticker 1 is typically damaged to such an extent it is rendered non-transferable.
3) Structures or elements which make any attempt to tamper with the sticker 1 visible or detectable. Examples of these include patterned adhesive and/or printed layers which break up or disintegrate when an attempt is made to remove the sticker from the substrate when adhered, one or more easily extensible layers which deform plastically when an attempt is made to remove the sticker. For instance, a sticker 1 coated with a high-adhesion adhesive can include a damageable layer. The damageable layer may be designed to exhibit optical properties, such as having a hologram or a kinegram. The damageable layer, e.g. the hologram or the kinegram, is destroyed upon an attempt to remove the a sticker from the substrate surface providing an indication of tampering and minimizing the risk of an undetected transfer of a permanently bonded article. Alternatively, for example, a multi-layer sticker 1 comprising flexible backing 16 having at least one damageable layer can be provided with a pressure-sensitive adhesive layer 22 wherein the pressure-sensitive adhesive layer is readily removable from a surface while still providing distortion of the damageable layer on removal.

Examples of these types of security features are disclosed for instance in EP 1 225 554, U.S. Pat. No. 6,372,341 and WO 97/44769. As an example a backing 16 may be provided with retroreflective elements, e.g. may comprise an enclosed layer of lenses that are coated in a spacing resin comprising, e.g., polyvinyl butyral or polyester as described in U.S. Pat. No. 2,407,680 (Palmquist et al). The spacing coat layer conforms to the lenses. A discontinuous release layer 20 may be applied in any suitable pattern onto the backing layer 16, e.g. a random or ordered pattern. The retroreflective backing 16 having a discontinuous release layer 20, also comprises markings 17, e.g. an ink layer, i.e. for providing the information 3, 4. The ink layer is applied directly to the backing layer 16 by any suitable marking or printing method. The ink layer advantageously colors or marks the splitting pattern of the release layer 20 to make the tampering indication even more noticeable and restoration attempts even more difficult Alternatively, the indicia 3, 4 may be provided by other means, e.g. by writing directly into the backing layer 16 using a laser. The backing layer 16 can comprise opaque materials such as silver, aluminum, chromium, nickel, or magnesium, or transparent high-index reflector materials such as zinc sulfide, or multi-layer reflectors as described in U.S. Pat. No. 3,700,305 (Bingham). For a retroreflective backing 16 a lens coat layer may be provided. In such embodiments, the lenses can be coated onto the lens coat layer and then the spacing coat layer can be coated onto the lenses. The lens coat layer can contain a colored pigment that gives the retroreflective backing layer 16 a colored appearance in normal light, and the appearance of a different color, such as silver, in retroreflective light. This is described further in U.S. Pat. No. 2,407,680 (Pamquist et al). The reverse side of the lens can be protected by a top coat layer made of any suitable protective or sealing material, such as PVC or an alkyd melamine resin.

The adhesive layer 22 as shown schematically in FIG. 3 binds strongly to the backing layer 16 wherever the release layer 20 is not present. On the other hand there is a reduced or little or no adherence of the adhesive layer 22 to the backing layer 16 where the release layer 20 is present. In general, the interlayer cohesive strength at the interface between the release layer 20 and the backing layer 16 or at the opposite face of the release layer 20 to the adhesive layer 22 is limited and is the weakest interlayer interface in the multi-layer sticker. Preferably, the release layer 20 comprises non-silicone material that provides limited interlayer cohesive strength. More preferably, the release layer 20 comprises a material selected from the group consisting of polyester resins, polyacrylate resins and mixtures thereof. Most preferably the release layer 20 comprises a polyester resin or a mixture of polyester resins. Suitable polyester resins include polyester resins conventionally applied in primer, gloss and/or protective coatings for printed polymeric films, such as the polyester resin used in product available under the trade designation BARGOFLEX Lack L 611 from Sicpa-Aarberg AG, Aarberg, Switzerland. Suitable polyacrylate resins include polyacrylates or acrylate copolymers, such as those conventionally applied as additives for improving leveling and/or to increase gloss of paints and powder coatings. Examples of suitable polyacrylate resins include the polyacrylates or acrylate copolymers used in products available under the trade designation BYK 354, BYK 355, BYK 358 and BYK 361 from BYK Chemie GmbH, D-46462, Wesel, Germany.

Preferably the adhesive layer 22 is a pressure-sensitive adhesive (PSA) layer. The adhesive layer 22 can also have other constructions, e.g. may be a film of PSA or may comprise several sublayers, e.g. can be a PSA-coated tape. The backing layer 16 carries a layer of PSA 22 on at least a portion of the first major surface thereof. The PSA material is chosen so as to provide bonds to the substrate (e.g. windshield) and the backing layer 16 that are of greater adhesive strength than the interlayer cohesive strength at the release layer 20. PSA-coated tapes and PSA films for use in preparing the sticker of the invention are preferably those which can be removed, without exhibiting cohesive failure, from a substrate surface by stretching. The application of such PSA films or PSA-coated tapes as the adhesive layer advantageously allows the provision of a tamper-indicating stickers, for example retroreflective stickers, which are removable without the aid of solvents and/or mechanical scraping and yet exhibit sufficiently high adhesion to the substrate for normal use. Such tamper-indicating retroreflective articles are particularly suitable for use as or for preparing temporary labels, stickers and the like. Useful PSAs include those acrylic PSAs, block copolymer PSAs, rubber resin PSAs, poly(alpha olefin) PSAs, and silicone PSAs that exhibit sufficient adhesion to a selected substrate to provide a bond that is durable under normal use conditions and sufficient stretchiness and cohesive strength alone and/or in combination with a carrier to be cleanly removable from the substrate by stretching. Acrylic PSAs and silicone PSAs are generally preferred due to their light-transmissive (more preferably, transparency) characteristics, with acrylic PSAs being more preferred. Optionally, the PSA layer(s) can contain one or more additives such as tackifying resins, plasticizers, antioxidants, fillers, and other common additives, depending upon the particular application.

A suitable backing layer 16 for the PSA layer includes both elastic and inelastic polymeric films that exhibit sufficient stretchiness (an appropriate Young's modulus to be manually stretchable) and tensile strength to enable the sticker 1 to be applied to and subsequently removed from a substrate surface by stretching the sticker manually. Representative examples of suitable polymer films include polyolefins, e.g., polyethylene, polypropylene, and polybutylene; vinyl polymers, e.g., poly(vinyl chloride) and poly(vinyl acetate); acrylic polymers; silicone polymers; natural or synthetic rubbers; polyurethanes; and blends thereof. Copolymers, e.g., ethylene/methacrylate, ethylene/vinyl acetate, acrylonitrile/butadiene/styrene, ethylene/propylene, and block copolymers (e.g., styrene-isoprene-styrene (SIS) or styrene-ethylene-butylene-styrene (SEBS)) can also be utilized. Polyolefins, especially polyethylene and polypropylene, and block copolymers are preferred. If desired, the backing layer 16 can be treated or its composition modified so as to enhance its adhesion to the PSA layer 22. For example, the backing layer 16 can be corona- or electron beam-treated or coated with an adhesion-promoting composition, or, alternatively, the backing layer can contain added adhesion-promoting compounds or chemical groups. The carrier can also contain other types of additives, e.g., fillers, tackifiers, or plasticizers.

During an attempt to remove the sticker 1 from the substrate, a portion of the sticker 1 including substantially any reflective layer or any backing layer 16 will split off (“split portion”), leaving substantially the remaining portion of the retroreflective sheet together with the adhesive layer 22 adhering to the substrate. The interlayer cohesive failure characteristics at the release layer 20 are preferably maintained over time and/or upon exposure to weathering stress.

In accordance with an embodiment of the present invention the separated first part 5 with indicia 3, 4 is attached to a suitable transparent substrate of an object, e.g. the windshield 23 of a transport vehicle and the separated second part 7 is attached to a document 24 that belongs logically to the object to which the first part of the sticker is attached (see FIG. 4). The substrate to which the first part is attached by adhesive layer 22 may be any suitable transparent substrate and it may be portable or pocket-sized and the present invention includes within its scope that this transparent substrate is flexible, semi-rigid or rigid and may be a transparent cover which forms an ID card, a bank card, a credit card, an entry ticket for a performance or service such as a museum or art gallery. For example, if the sticker 1 has been attached to the windshield 23 of a car or other vehicle, the document 24 (see FIG. 4) could be a car registration document or could be card in a card file. By “document” is meant any suitable flat material which can be stored, e.g. paper, plastic sheet, a card file, etc. Since the second information 13 on the second part 7 of the sticker 1 is related to some of the information 3, 4 on the first part 5 of the sticker 1 or is protected against forgery such that this latter information 3, 4 can be derived from the second information 13, inspection of the document and the sticker 1 can easily reveal whether the sticker 1 belongs to this car. The second part 7 of the sticker 1 may also include an adhesive layer and a liner, the adhesive layer being applied to the first major surface in the third area. This adhesive layer is preferably the adhesive layer 22 mentioned above. When the second part 7 of the sticker 1 is attached to the document, it is preferred to use the adhesive layer 22 which is applied to the third area 8 on the first major side of the sticker 1. This part is applied by removing the liner 18 before attachment to the document 24. The relevant information on the second part 7 is visible from the second major surface side of the second part 7, and is therefore visible when the second part 7 is attached to the document 24.

In accordance with a further aspect of the present invention the first information or a part thereof and/or the second information or a part thereof can also be entered into a computer system 30 for storage of this information in a non-volatile digital form (see FIG. 4). A purpose of the computer system 30 is to store information on the sticker 1 and to relate it to other relevant information, e.g. to the license plate number of the vehicle, name and address of the owner of the vehicle, etc. Preferably, the information is stored in a computer searchable form, namely searchable by means of the first information on the first part 5 of the sticker 1 or by means of information uniquely derivable from this information such as the second information or for example by entry of a license plate number of a vehicle. This allows the relevant information for the transport vehicle to be recalled via a computer search and provides added security to the system against forgery of the sticker and/or the document and/or transfer of the first part of the sticker 1 to another vehicle as then the complete data stored in the computer system would not be consistent. To this end the present invention can include a reading device 28 to which the sticker 1 can be presented and read. For example, if the sticker 1 contains holes punched in the first part 5 or embossing on the sticker or other means of identifying certain information such as an expiry date or a validity date, the reader 28 includes a means for detecting these holes or other means, e.g. by mechanical, optical, electrical or magnetic sensors and for automatically recording the detected data in computer system 30. If the sticker 1 includes a barcode the reader 28 may include a barcode reader. Computer system 30 may include one or more computers 27 such as personal computers or workstations. The relevant data from sticker 1 may also be entered manually, e.g. via a keyboard. The computer system 30 may also include a central server 29 including memory 25 and a processor 26 connected to the computer 27 by means of a network, such as a Iocal area network, a wide area network, a metropolitan area network or similar, e.g. via Internet access. The data captured from stickers 1 or entered manually can be transferred to the central server 29, e.g. via a telecommunications system and stored in memory 25, e.g. mass storage. This information may be accessed electronically. For example, the first major surface of the first part of the sticker 1 when attached to the transparent object may be scanned for example by a mobile phone equipped with a camera and/or a suitable reader, e.g. a barcode reader. Alternatively, this information may be entered into the mobile phone using a keyboard. This information and/or image is then transferred by a wireless telecommunications system, e.g. the GPRS service of GSM mobile telephone operators; to computer system 30. The transferred information is then used to retrieve information relating to the relevant sticker 1 from the memory 25 of server 29. This retrieved information is then returned to the mobile phone, e.g. by an alphanumeric data transfer method such as the Short Message Service (SMS) of a GSM mobile telephone operator. In case of dispute, the relevant document 24 could also be consulted. Accordingly, in an aspect of the present invention the first information on the sticker 1 may be used to retrieve the second information from the computer system 30 or vice versa, or to retrieve other data. Alternatively, other data may be used to retrieve relevant information, e.g. the license plate number of the relevant vehicle can be entered into the computer system 30 and the system returns at least the first and second information. Further, the computer system may include a decoder, e.g. running as a software program on a PC or on the server, whereby the second information is a key that is used by the decoder to decode the first information into data relevant to the vehicle.

### EXAMPLE 1

A continuous roll of flexible sheeting having a width of 100 mm comprising
a.) a polyester film having a thickness of 50 μm,
b.) a retro-reflective sheet comprising glass beads and having a thickness of ca. 75 microns,
c.) a pattern-coating of transparent release material and
d.) a 80 μm thick transparent polymeric film comprising translucent holograms was used as a substrate.

The roll of sheeting was then pre-printed for its full length with indicia on the front surface (layer d) including a grid 4 for manual punching of an expiration date of the validation sticker. The indicia 4 were printed on the first part 5 of the sticker 1.

The sheet was then printed with variable indicia 3, 13 (such as a serial number) on the front surface (layer d. from above) and the rear surface (layer a. from above) simultaneously using a thermal transfer printer. Indicia 3 on the front surface was printed in area 2. Indicia 13 on the rear surface comprised the indicia 3 as printed on the front surface (layer d), and was printed on the second part 7 of the sticker 1. The information printed on the web was changed in a serial fashion so that each section of the continuous roll was unique.

A three layer laminate was then prepared by applying a layer of acrylic pressure-sensitive adhesive (PSA) to each side of a 40 μm thick polymeric film comprising a stretchable linear low density polyethylene (LLDPE). The PSA layer applied to the first side of the polymeric film was a lower adhesion acrylic PSA designed to participate in a fracture mechanism on attempts to remove the sticker from the windshield. The PSA layer applied to the second side of the polymeric film was an acrylic PSA designed to adhere immediately and aggressively to a glass substrate such as a windshield. Each side of the adhesive laminate was protected by a release liner. In particular, the adhesive layer intended for the glass surface was protected by a transparent release liner (18) to facilitate date punching before application to the glass surface.

The liner protecting the PSA layer on the first side of the polyester film was removed and the exposed adhesive layer was then laminated with pressure to the entire front surface of the printed sheet.

The roll thus prepared was then perforated along its entire length in down-web direction, dividing the web into two parts: a first part 5 and a separable second part 7.

Individual identification stickers 1 were then severed from the web by cutting it in the cross web direction. Each sticker 1 produced in this manner carried a unique indicia 3 printed on the front surface in the area 2 and the same indicia 13 on the rear surface on the separable second part 7.

To use the sticker 1 thus prepared, the two parts 5, 7 were first separated manually along the perforation line 6. The first part was then punched with a hole-puncher to indicate the day, month and year of sticker expiration.

The release liner 18 was removed from the first part and the sticker 1 was adhered to the inside surface of a vehicle windshield. The variable indicia 3 and the expiration date 4 were visible from outside the vehicle.

The release liner 18 was removed from the second part 7 and the second part was then adhered to the car title papers. The variable indicia 13 on the rear surface of the second part were then visible on the document. The same indicia 13 with additional details as to the vehicle, e.g. manufacturing date, type, capacity, number of passenger seats, first date of registration, name and address of owner were then entered into a computer systems maintained by the authority issuing the sticker.

### EXAMPLE 2

Example 1 was repeated with the exception that the three-part PSA-bearing laminate was replaced by a single layer of acrylic pressure-sensitive adhesive (PSA) protected by a release liner. The adhesive has high adhesion to glass and had a thickness of ca. 25 microns.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims. For example, the first information may be attached to a vehicle by means of the adhesive layer 22 and the second information is attached either to the vehicle registration papers kept in the vehicle or kept in a registration office. The document in the registration office may be filed under the license plate number, name of the owner rather than being filed under the first or second information. The sticker 1 may be used for single transports, e.g. when dutiable goods are transferred. The sticker giving allowance to a single transport. The second information may be included on several second parts of the sticker, each second part being separated from the sticker and applied to access means such as doors or windows such as to seal them. Any tampering with the contents inside the vehicle requires opening of the doors or windows which breaks the seals. The second parts may also be attached to goods rather than to documents.

1. A security sticker comprising one or more security features on a backing layer having opposite first and second major sides, said first major side having a transparent or translucent adhesive layer applied at least to a first part thereof and a liner on a side of the adhesive layer remote from said backing layer, said first major side having in a first part of said security sticker a first area containing one or more indicia describing first information to be displayed and to be protected against forgery and/or tampering in a first mode of use and said second major side having in a second part of said security sticker a second area located opposite to a third area on said first major side that does not contain information to be displayed and protected in said first mode of use, said second area comprising a section being adapted to receive second information or containing second information and said second information being related to all or part of said first information contained on said first major side in said first part.

2. The security sticker according to claim 1, wherein the all or part of the first information is information-content related to all or part of the second information.

3. The security sticker according to claim 1, wherein all or part of the first information is related cryptographically to all or part of the second information.

4. The security sticker according to claim 1, wherein there is a unique relationship between the first and second information, the unique relationship being proof that the first and second information belong to each other.

5. The security sticker according to claim 1, wherein the first and second information are identical or the first information is derivable from the second information or vice versa.

6. The security sticker according to claim 1, wherein said security features comprise a hologram, a watermark or a retro reflective layer.

7. The security sticker according to claim 1, wherein said sticker comprises means for facilitating separation of said first and second part of the security sticker.

8. A method of operating a document security system, comprising:
providing at least one sticker according to claim 1;
removing the second part from the at least one sticker; and
attaching the second part to a document.

9. The method according to claim 8, attaching the first part of the sticker to at least one object.

10. A document security system comprising:
a security sticker one or more security features on a backing layer having opposite first and second major sides, said first major side having a transparent or translucent adhesive layer applied at least to a first part thereof and a liner on a side of the adhesive layer remote from said backing layer, said first major side having in a first part of said security sticker a first area containing one or more indicia describing first information to be displayed and to be protected against forgery and/or tampering in a first mode of use and said second major side having in a second part of said security sticker a second area located opposite to a third area on said first major side that does not contain information to be displayed and protected in said first mode of use, said second area comprising a section being adapted to receive second information or containing second information and said second information being related to all or part of said first information contained on said first major side in said first part;
a first object having the first part of the sticker attached thereto; and
a second object having the second part of the sticker attached thereto.
